(19) United States
(12) Patent Application Publication
(10) Pub. No.: US 2003/0234888 A1
(43) Pub. Date: Dec. 25, 2003

(54) Carried image processing device

(76) Inventors: Jia-Cherng Hong, Chu-Pei City (TW); Tom Tang, Chu-Nan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/178,491

(22) Filed: Jun. 25, 2002

(51) Int. Cl. H04N 5/225; H04N 5/228

(52) U.S. Cl. 348/375; 348/376; 348/222.1; 348/220.1

(57) ABSTRACT

The present invention relates to a carried image processing device. The carried image processing device comprises a base, a rotational cantilever, a handle, the first rotating shaft, the second rotating shaft, the third rotating shaft, an image collecting device, and an image collecting device holder, wherein the rotational cantilever and the handle are connected to the base by using the first rotating shaft and the third rotating shaft and the image collecting device holder is connected to the rotational cantilever by using the second rotating shaft. The base of the present invention comprises a circuit module, a control key module, the first communication port, and a power connector. The image collecting device of the present invention comprises an optical module, the first memory, a chip, a timing generator, a light source, and a power supply device, wherein the chip comprises a microprocessor control unit (MCU) and a color processor and the optical module comprises a lens, a infrared cut and optical low pass filter, and a charge coupled device (CCD). The optical module, the first memory, the timing generator, and the light source are coupled with the chip. The circuit module of the present invention comprises a scalar integrated circuit (IC), the second memory, and a digital/analog signal transforming device. The second memory and the digital/analog signal transforming device are coupled with the scalar integrated circuit.

### BACKGROUND OF THE INVENTION

1. Field of the Invention

The present invention relates to an image processing device, more particularly, to a carried image processing device to increase functions of the image processing device and increase the working efficiency of the user. The carried image processing device of the present invention can further decrease the cost of the user.

2. Description of the Prior Art

For present information users, especially to the personal computer users, a mode of the computer information has been changed from an unexciting word mode to a multi-media mode. The multi-media mode means that the information comprises words, images, and sounds. In order to show the multi-media mode in the face of viewers, various multi-media devices, which can collect the images and sounds, are developed. Because the multi-media information comprises more matters, memories, which are used to deal with the multi-media information, are greater than memories, which are used to deal with the unexciting word information to show the multi-media information more smoothly.

In traditional speeches, speakers usually use an overhead projector to express their ideas more clearly. The speakers must put projection films, which are prepared before the speech, on the overhead projector to project an image on a wall or on a projection curtain. The image is information, which is written on the projection film and the user wants to express. This way will make the audiences understand and absorb the ideas of the speakers more quickly. But it will cost more time to make the traditional projection films and the outcome of the speech by using this way is not very perfect. When the speaker has new information and wants to explain for the audiences in the temporary, the speaker will not show the new information on the projection curtain for the audiences.

In the present, the speaker can use the overhead projector and the object overhead projector at the same time in the speech to let the audiences understand the subject matters of the speech more quickly. But a volume of the object overhead projector is bigger and a price of the object overhead projector is higher, the user will use the object overhead projector inconveniently. In the present, another choice of the speaker to assist the contents of the speech is to use a computer. The user can make the information, which was written on the projection films, become the computer files by using the computer software, such as: powerpoint, and show the files on the monitor to let the audiences understand the contents of the speech more quickly. When the speaker has new information, which is not made to become the computer file, and wants to explain for the audiences in the temporary, the speaker will still use the object overhead projector to show the new information on the projection curtain for the audiences. The object overhead projector and the computer are the expensive and are carried inconveniently. Therefore, the speakers usually use the projection films and the overhead projector to be the auxiliary tools in the general speech.

### SUMMARY OF THE INVENTION

In accordance with the background of the above-mentioned invention, the price of the traditional briefing tool is too expensive and the using mode of the traditional briefing tool is more inconvenient. The present invention provides a carried image processing device to decrease the cost of the user.

The second objective of the present invention is to provide the carried image processing device to increase the working efficiency of the user.

The further objective of the present invention is to provide the carried image processing device to increase the using scope of the image processing device.

In according to the foregoing objectives, the present invention provides the carried image processing device to increase the using scope of the image processing device. The carried image processing device of the present invention comprises a base, a rotational cantilever, a handle, the first rotating shaft, the second rotating shaft, the third rotating shaft, an image collecting device, and an image collecting device holder, wherein the rotational cantilever and the handle are connected to the base by using the first rotating shaft and the third rotating shaft and the image collecting device holder is connected to the rotational cantilever by using the second rotating shaft. The base of the present invention comprises a circuit module, a control key module, the first communication port, a power connector, and a skid cushion module. The rotational cantilever of the present invention is a rotational cantilever whose length can be lengthened and shortened, wherein the rotational cantilever comprises a signal line, the first adjuster and the second adjuster. The first adjuster is used to control the length of the rotational cantilever and the second adjuster is used to control a location of the image collecting device holder. The rotational cantilever can rotate by using the first rotating shaft to be the rotational center shaft. The image collecting device holder of the present invention comprises the second communication port to connect to the image collecting device. The second communication port is connected to the circuit module by using the signal line, which is in the rotational cantilever to transmit image data, which are collected by the image collecting device. The image collecting device holder further comprises the third adjuster to fix the image collecting device. The image collecting device holder can rotate by using the second rotating shaft to be the rotational center shaft. The image collecting device of the present invention comprises an optical module, the first memory, a chip, a timing generator, a light source and a power supply device, wherein the chip comprises a microprocessor control unit (MCU) and a color processor and the optical module comprises a lens, a infrared cut and optical low pass filter, and a charge coupled device (CCD). The optical module, the first memory, the timing generator, the light source, and the power supply device are coupled with the chip. The circuit module of the present invention comprises a scalar integrated circuit (IC), the second memory, and a digital/analog signal transforming device. The second memory and the digital/analog signal transforming device are coupled with the scalar integrated circuit. The present invention can also decrease the cost of the user and increase the working efficiency of the user.

### BRIEF DESCRIPTION OF THE DRAWINGS

In the accompanying drawing forming a material part of this description, there is shown:

FIG. 1 is a top plan view of the carried image processing device of the present invention;

FIG. 2 is a bottom plan view of the carried image processing device of the present invention;

FIG. 3 is a right side elevational view of the carried image processing device of the present invention;

FIG. 4 is a left side elevational view of the carried image processing device of the present invention;

FIG. 5 is a front elevational view of the carried image processing device of the present invention;

FIG. 6 is a rear elevational view of the carried image processing device of the present invention;

FIG. 7 is a three dimensional view of the carried image processing device of the present invention;

FIG. 8 is a diagram showing the elements of the image collecting device of the present invention;

FIG. 9 is a diagram showing the circuit module that is fixed in the inside of the base; and

FIG. 10 is a three dimensional view of using the carried image processing device of the present invention.

### DESCRIPTION OF THE PREFERRED EMBODIMENT

The foregoing aspects and many of the intended advantages of this invention will become more readily appreciated as the same becomes better understood by reference to the following detailed description, when taken in conjunction with the accompanying drawings, wherein:

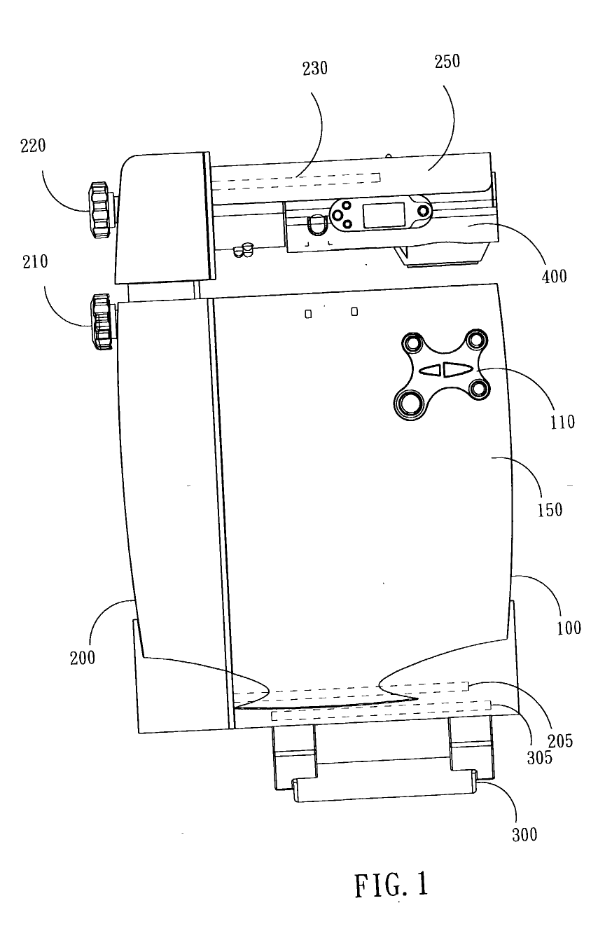

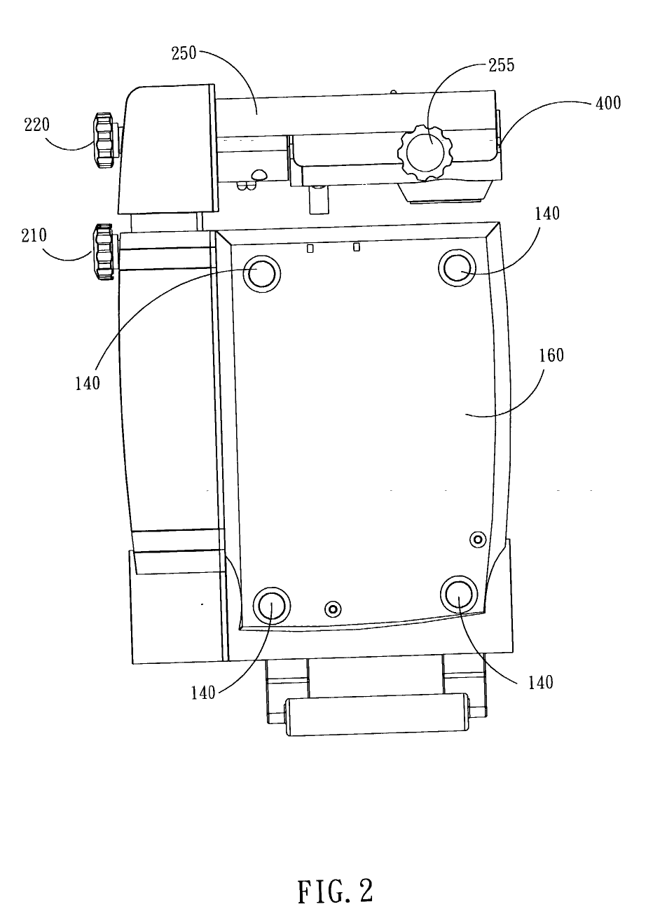

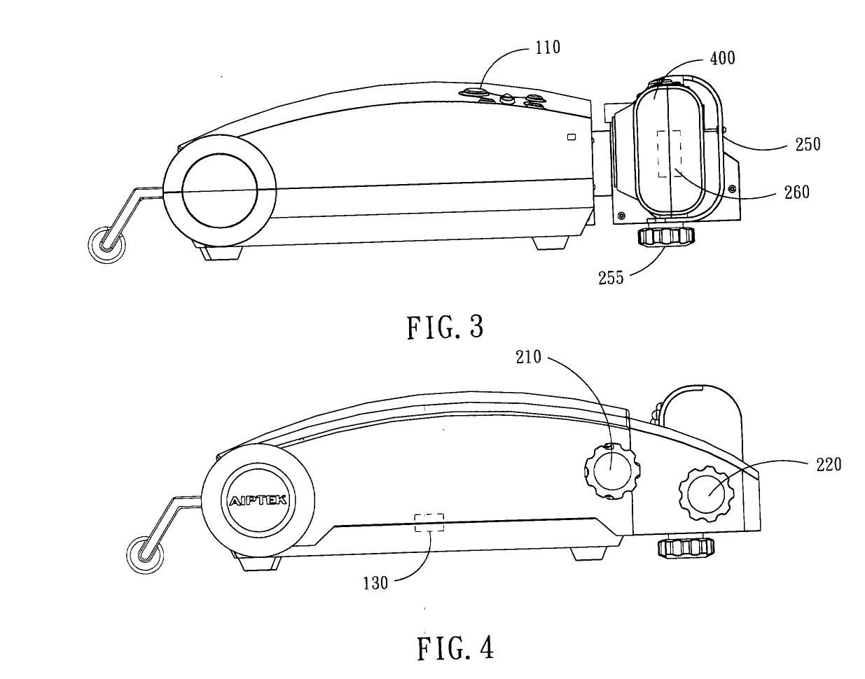

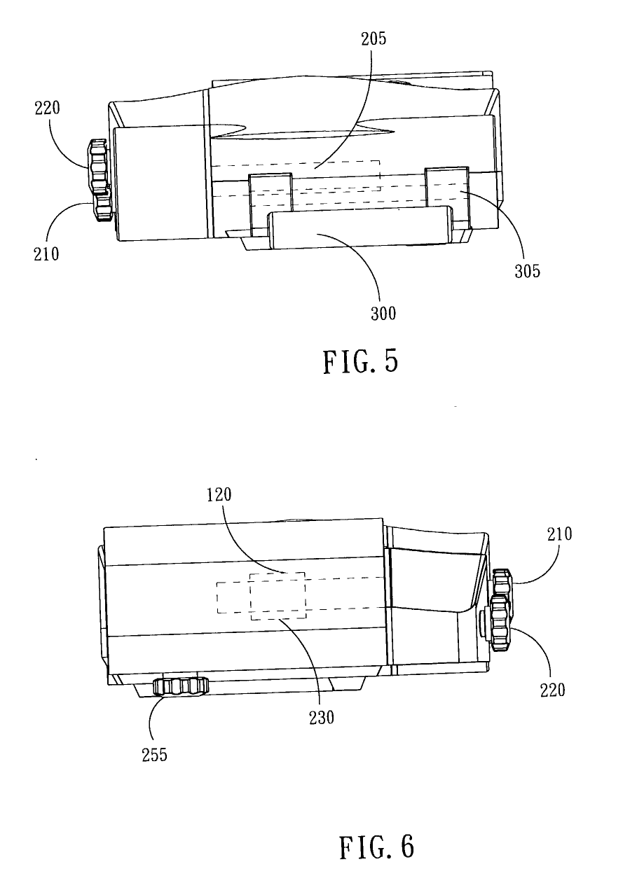

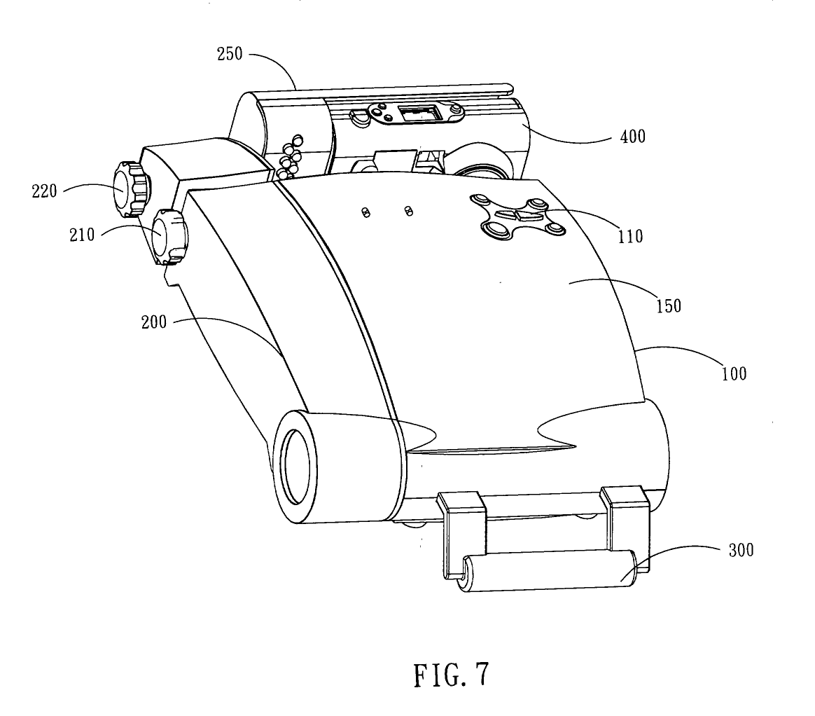

Referring to FIG. 1 this shows a top plan view diagram of the carried image processing device of the present invention. Referring to FIG. 2, this shows a bottom plan view diagram of the carried image processing device of the present invention. Referring to FIG. 3, this shows a right side elevational view diagram of the carried image processing device of the present invention. Referring to FIG. 4, this shows a left side elevational view diagram of the carried image processing device of the present invention. Referring to FIG. 5, this shows a front elevational view diagram of the carried image processing device of the present invention. Referring to FIG. 6, this shows a rear elevational view diagram of the carried image processing device of the present invention. Referring to FIG. 7, this shows a three dimensional view diagram of the carried image processing device of the present invention.

The carried image processing device of the present invention comprises a base 100, a rotational cantilever 200, a handle 300, the first rotating shaft 205, the second rotating shaft 230, the third rotating shaft 305, an image collecting device 400, and an image collecting device holder 250, wherein the rotational cantilever 200 and the handle 300 are connected to the base 100 by using the first rotating shaft 205 and the third rotating shaft 305 and the image collecting device holder 250 is connected to the rotational cantilever 200 by using the second rotating shaft 230. The base 100 of the present invention comprises a circuit module, a control key module 110, the first communication port 120, a power connector 130, and a skid cushion module 140.

The base 100 of the present invention comprises a control key module 110 to control the circuit module, which is fixed in the inside of the base 100, and make the image can be inputted and outputted successfully. The control key module can also be used to control a dpi (Dot Per Inch) of the image. The base 100 of the present invention also comprises a power connector 130 to provide an electric power for the carried image processing device or to proceed a charging procedure for a battery, which is fixed in the inside of the base 100. The base 100 of the present invention further comprises the first communication port 120 to transmit the image data, which is saved in the carried image processing device, to a monitor. The base 100 of the present invention furthermore comprises a skid cushion module 140 to prevent the sliding condition of the base 100, which will damage the carried image processing device, when the user uses the carried image processing device of the present invention.

The rotational cantilever 200 of the present invention is a rotational cantilever whose length can be lengthened and shortened. The rotational cantilever 200 is connected to the base 100 by using the first rotating shaft 205 and can rotate by using the first rotating shaft 205 to be the rotational center shaft. The length of the rotational cantilever 200 can be adjusted following the needs of the user, wherein the rotational cantilever 200 comprises a signal line, the first adjuster 210, the second adjuster 220 and the image collecting device holder 250. The first adjuster 210 is used to control the length of the rotational cantilever 200. When the length of the rotational cantilever 200 needs to be adjusted, the first adjuster 210 can be used to adjust the length of the rotational cantilever 200 and can be fixed the length of the rotational cantilever 200 to provide conveniences for the user. Following different needs of the products, the length of the rotational cantilever 200 of the present invention can be fixed and cannot be adjusted. The image collecting device holder 250 is connected to the rotational cantilever 200 by using the second rotating shaft 230. The image collecting device holder 250 can rotate by using the second rotating shaft to be the rotational center shaft and can be used to control a location of the image collecting device holder. Following needs of the products, the image collecting device holder 250 can be connected to the rotational cantilever 200 by using a ball bearing way to make the image collecting device holder 250 rotate more flexibility.

The image collecting device holder 250 comprises the third adjuster 255 and the second communication port 260. When the image collecting device 400 is connected to the rotational cantilever 200 by using the second communication port 260, the user can fix the image collecting device 400 on the image collecting device holder 250 by using the third adjuster 255 to prevent the image collecting device 400 coming off the image collecting device holder 250. In usual, a digital is usually used to be the image collecting device 400 of the present invention. The rotational cantilever 200 of the present invention also comprises a signal line to connect the second communication port 260 and the circuit module, which is in the base 100, with each other. When the image collecting device 400 gets image data, the image data will transmit from the second communication port 260 to the circuit module, which is in the base 100, by using the signal line to pass through a image processing. The image collecting device holder further comprises a light source to provide an enough light for the image collecting device 400. The carried image processing device further comprises a handle 300. The handle 300 is connected to the base 100 by using the third rotating shaft 305 to provide the user carrying the carried image processing device of the present invention more conveniently. Following needs of the user, the third rotating shaft 305 can rotate by using said third rotating shaft to be the rotational center shaft or can be fixed on the base 100 in an angle.

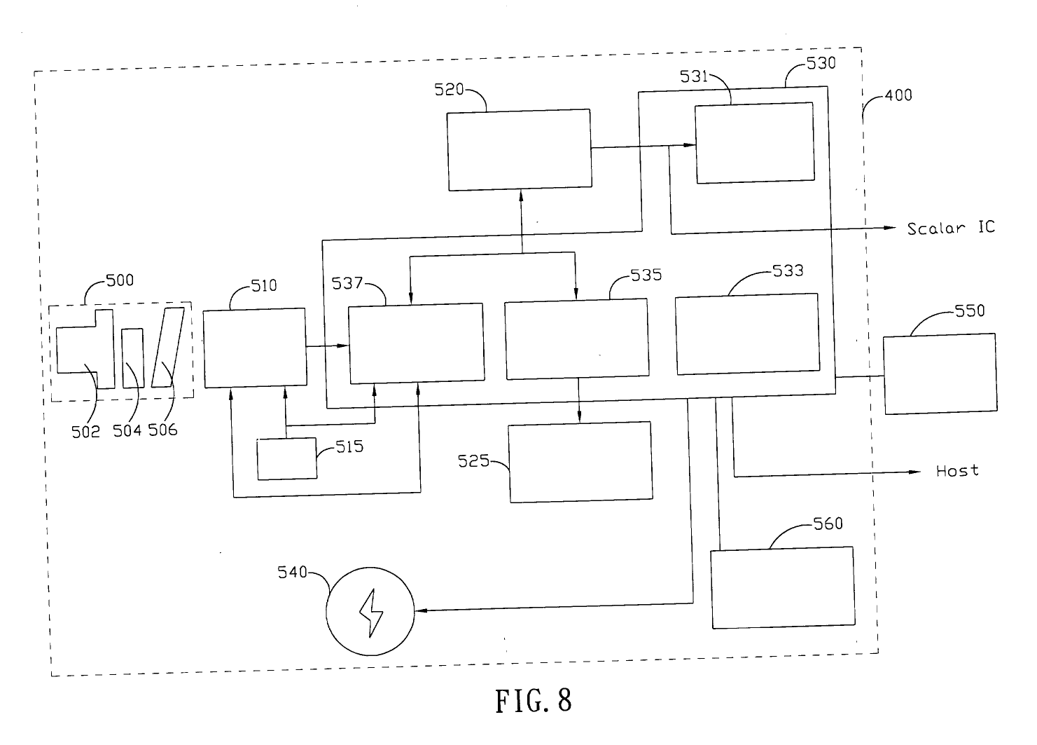

Referring to FIG. 8, this shows a diagram in showing the elements of the image collecting device of the present invention. The image collecting device 400 of the present invention comprises an optical module 500, the first memory 520, a chip 530, a timing generator 515, a light source 540, and a power supply device 560, wherein the chip 530 comprises a microprocessor control unit (MCU)533 and a color processor 537 and the optical module 500 comprises a lens 502, a infrared cut and optical low pass filter 504, and a charge coupled device (CCD) 506. In the present invention, the charge coupled device 506, which is used in the optical module 500, can be replaced by using a complementary metal-oxide semiconductor sensor (CMOS sensor) to decrease the consumption on electric power. The lens of the present invention is the lens whose focal length is fixed, the lens whose focal length can be adjusted by using hands, or the lens whose focal length can be adjusted automatically to collect the image clearly. The lens 502 is coupled with the infrared cut and optical low pass filter 504 and the infrared cut and optical low pass filter 504 is coupled with the charge coupled device 506. The optical module 500, the first memory 520, the timing generator 515, the light source 540, and the powersupply 560 are coupled with the chip 530. The power supply device 560 can be an exterior power source or electric power which comes from the base to provide electric power to the image collecting device. Therefore, the power supply device 560 of the present invention can be a dry battery. The user can choose what kinds of power supply device following needs of the user. After an image is caught by using the optical module 500, which comprises the lens 502, the infrared cut and optical low pass filter 504, and the charge coupled device 506, the image passes through an analog signal processing (ASP) to become an image data. Then the image data are transmitted to the chip. A dpi (dot per inch) of the image data is transformed to become the dpi which user needs by using the microprocessor control unit 533 that is in the chip to proceed with a color processing process 537. After the color processing process, the image data can be saved in the first memory 520 in the joint photographic experts group (JPEG) mode or in the memory card 525. The user can call this image data in any time. In usual, a memory buffer is used as the first memory 520. The image which is caught by using the optical module can be showed on television by transforming the image data, which are saved in the memory buffer 520 or memory card in a television encoding process 530. The image data, which passed through the chip process, can also be saved in a programmable read-only memory (PROM) 550 to provide uses for the user. The image data, which passed through the chip process, can further be transmitted to the host to provide uses for the user. The timing generator 515 is usually used in the analog signal processing process 510 to control generating time of the signal. The image collecting device of the present invention further comprises a light source 540 to complement the insufficient light of the catching image environment. A flash light is usually used as the light source 540 of the present invention. In order to cooperate the circuit module which is fixed in the inside of the base of the present invention, the image data are caught to transmit in the circuit module of the base without the television encoding process 531.

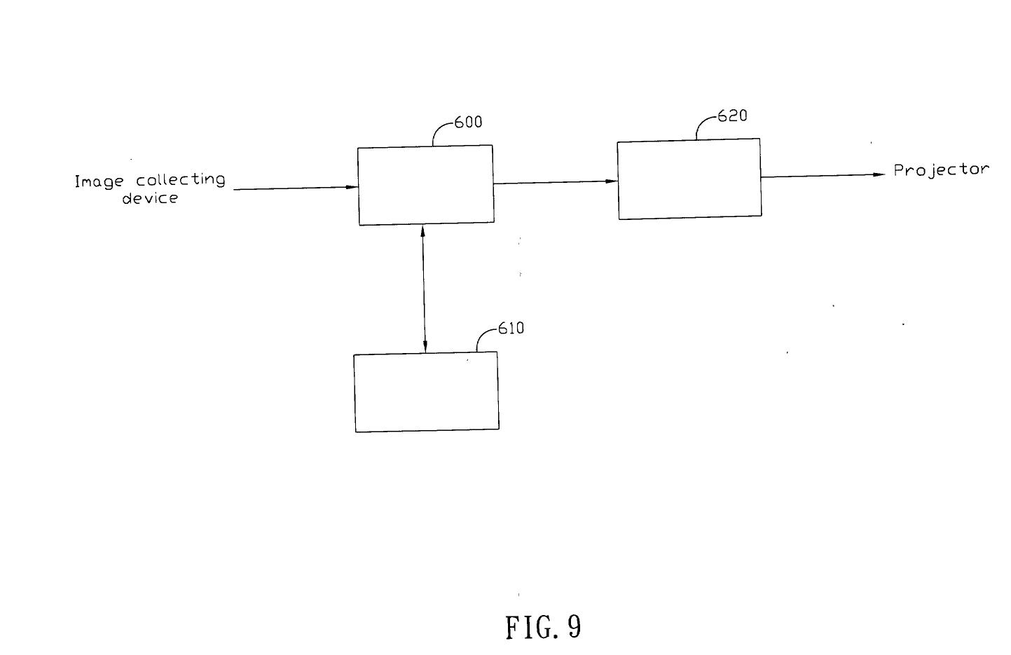

Referring to FIG. 9, this shows a diagram in showing the circuit module that is fixed in the inside of the base. The circuit module, which is fixed in the inside of the base, of the present invention comprises a scalar integrated circuit (IC) 600, the second memory 610, and a digital/analog signal transforming device 620. The second memory 610 and the digital/analog signal transforming device 610 are coupled with the scalar integrated circuit 600. The scalar integrated circuit 600 is used to control a size of the image and to adjust the amount of the frame rate and the frame size to transform the standard of the image data cooperating for the requirement of the projector. The “frame” is a unit of a data transmitting process. When data of a computer are transmitted from a transmitting interface, the data will be divided into plural basic units and each basic unit comprises transmitting source, transmitting objective, and transmitting block corresponding to which blocks of files. The transmitting block is called a frame. A dynamic random access memory (DRAM) is usually used as the second memory to save the image data, which pass through the scalar integrated circuit process. After the image data, which are transmitted from the image collecting device, being transformed by the scalar integrated circuit 600, the image data must pass through a digital/analog signal transforming device 620 to make the image data become the analog signals cooperating to the standard of the projector. The user can adjust a set value of the scalar integrated circuit by using the control key module that is in the base to make the image which is projected on the projection curtain cooperate to needs of the user.

The image collecting device also comprises an auto-switch to change a dynamic image collecting mode and a static image collecting mode with each other and make the image collecting device can catch a dynamic image and a static image. In usual, the image collecting device is usually used to collect the dynamic image. When the user want to get a static image, the user can use a collecting key of the image collecting device to catch a static image immediately. The image collecting device of the present invention further comprises an auto-detecting function. When the user open this detecting function, the image collecting can change the dynamic image collecting mode to become the static image collecting mode automatically to collect the image in static image collecting mode after the image collecting device detects and judges the image without any change for period time. The period can be adjusted by using the adjusting key of the image collecting device. When the user want to show a dynamic image on the project curtain, the user can adjust the image collecting device of the present invention in the dynamic image collecting mode. When the image collecting device catches the image in dynamic image collecting mode, the dpi used in the image collecting device is lower. Then the dynamic image whose dpi is lower is transmitted to the circuit module of the base to proceed with the digital/analog signal transforming process. At last, the dynamic image whose dpi is lower is projected on the projection curtain or showed on screen of television directly. When the user want to show a static image on the project curtain, the user can adjust the image collecting device of the present invention in the static image collecting mode. When the image collecting device catches the image in static image collecting mode, the dpi used in the image collecting device is higher. Then the static image whose dpi is higher is transmitted to the circuit module of the base to proceed with the digital/analog signal transforming process. At last, the static image whose dpi is higher is projected on the projection curtain or showed on screen of television directly. The image collecting device 400 can be further used alone to be a digital camera. The image collecting device 400 has common functions of the digital camera and comprises a digital print order format (DPOF) in its inside. The user can print the image, which is saved in the image collecting device, by using a printer directly.

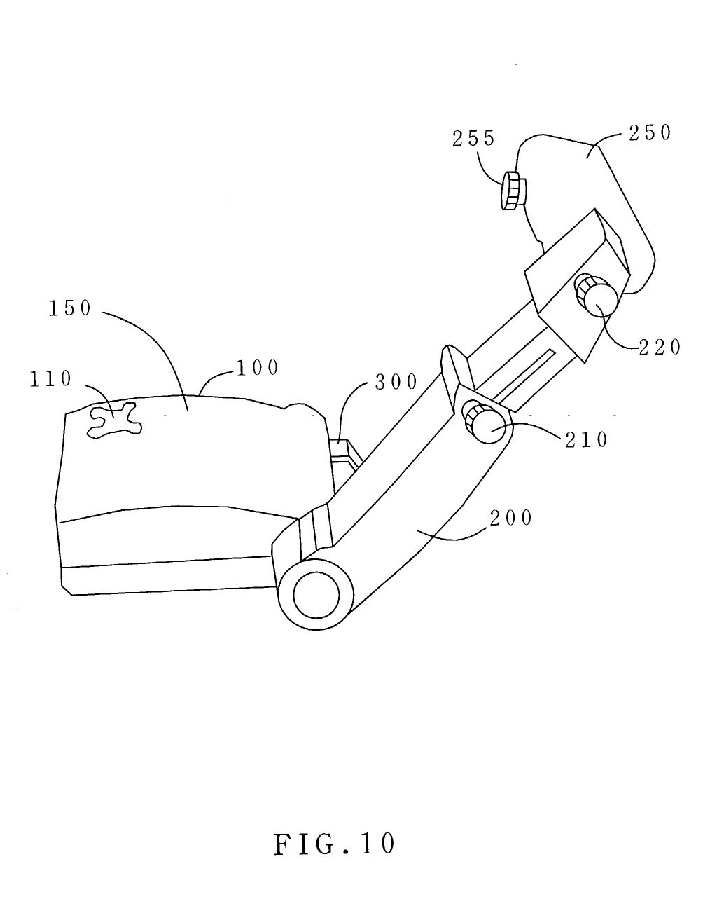

Referring to FIG. 10, this shows a three dimensional view diagram of using the carried image processing device of the present invention. When the user carries the carried image processing device of the present invention at a place and wants to use it, the user can connect the first communication port of the carried image processing device to a monitor by using a image signal line quickly. Following the using time of the user, if the output power is connected to the carried image processing device or not. The user usually uses a power line to connect the power connector to the output power to avoid the power failure. Then the user shows the image data, which were saved in the carried image processing device, on the monitor by using the control key module for audiences to make the user proceed a speech or a briefing more conveniently. When the user wants to use the information, which is not saved in the circuit module of the base 100, the user can adjust the rotational cantilever by using the first rotating shaft to a suitable angle and adjust the length of the rotational cantilever by using the first adjuster to become a suitable length. Next, the user can adjust an angle of the image collecting device, which is fixed on the image collecting device holder, by using the second adjuster to make the image collecting device get the information to become an image data. The image data will transmit from the second communication port, which is fixed Qn the image collecting device holder, to the circuit module of the base by using the signal line. The user can use the control key module of the base to control the image data and show the image data on the monitor. When there is no computer and projector in the using environment of the carried image processing device, the user can use the carried image processing device of the present invention to show the image on the screen of the television.

In accordance with the present invention, the present invention provides the carried image processing device to increase the using scope of the image processing device. The carried image processing device of the present invention comprises a base, a rotational cantilever, a handle, the first rotating shaft, the second rotating shaft, the third rotating shaft, an image collecting device, and an image collecting device holder, wherein the rotational cantilever and the handle are connected to the base by using the first rotating shaft and the third rotating shaft and the image collecting device holder is connected to the rotational cantilever by using the second rotating shaft. The base of the present invention comprises a circuit module, a control key module, the first communication port, a power connector, and a skid cushion module. The rotational cantilever of the present invention is a rotational cantilever whose length can be lengthened and shortened, wherein the rotational cantilever comprises a signal line, the first adjuster and the second adjuster. The first adjuster is used to control the length of the rotational cantilever and the second adjuster is used to control a location of the image collecting device holder. The rotational cantilever can rotate by using the first rotating shaft to be the rotational center shaft. The image collecting device holder of the present invention comprises the second communication port to connect to the image collecting device. The second communication port is connected to the circuit module by using the signal line, which is in the rotational cantilever to transmit image data, which are collected by the image collecting device. The image collecting device holder further comprises the third adjuster to fix the image collecting device. The image collecting device holder can rotate by using the second rotating shaft to be the rotational center shaft. The image collecting device of the present invention comprises an optical module, the first memory, a chip, a timing generator, a light source, and a power supply device, wherein the chip comprises a microprocessor control unit (MCU) and a color processor and the optical module comprises a lens, a infrared cut and optical low pass filter, and a charge coupled device (CCD). The optical module, the first memory, the timing generator, the light source, and the power supply device are coupled with the chip. The circuit module of the present invention comprises a scalar integrated circuit (IC), the second memory, and a digital/analog signal transforming device. The second memory and the digital/analog signal transforming device are coupled with the scalar integrated circuit. The present invention can also decrease the cost of the user and increase the working efficiency of the user.

Although specific embodiments have been illustrated and described, it will be obvious to those skilled in the art that various modifications may be made without departing from what is intended to be limited solely by the appended claims.

What is claimed is:

1. A carried image processing device, wherein said carried image processing device comprises:
a base, said base comprising a control key module, a first communication port, and a circuit module, wherein said circuit module comprises a scalar integrated circuit, a first memory, and a digital/analog signal transforming device and said first memory and said digital/analog signal transforming device are coupled with said scalar integrated circuit;
a rotational cantilever, said rotational cantilever being connected to said base by using a first rotating shaft;
an image collecting device holder, said image collecting device holder comprising a second communication port and being connected to said rotational cantilever by using a second rotating shaft;
an image collecting device, said image collecting device being connected to said image collecting device holder by using said second communication port, wherein said image collecting device comprises:
an optical module, said optical module being used to catch image data;
a chip, said chip comprises a microprocessor control unit;
a second memory, said second memory being coupled with said chip;
a timing generator, said timing generator being coupled with said chip; and
a light source, said light source being coupled with said chip.

2. The method according to claim 1, wherein said scalar integrated circuit is used to control a size of said image.

3. The method according to claim 1, wherein said rotational cantilever comprises a first adjuster.

4. The method according to claim 3, wherein said first adjuster is used to adjust a length of said rotational cantilever.

5. The method according to claim 1, wherein said rotational cantilever comprises a second adjuster.

6. The method according to claim 5, wherein said second adjuster is used to adjust said image collecting device holder.

7. The method according to claim 1, wherein said rotational cantilever comprises a third adjuster.

8. The method according to claim 7, wherein said third adjuster is used to adjust said image collecting device.

9. The method according to claim 1, wherein a length of said rotational cantilever is fixed.

10. The method according to claim 1, wherein said light source is a flash light.

11. The method according to claim 1, wherein said first memory is a dynamic random access memory.

12. The method according to claim 1, wherein said second memory is a memory buffer.

13. The method according to claim 1, wherein said image collecting device comprises an auto-switch to change a dynamic image collecting mode and a static image collecting mode with each other.

14. A carried image processing device, wherein said carried image processing device comprises:
a base, said base comprising a control key module, a power connector, a first communication port, and a circuit module, wherein said circuit module comprises a scalar integrated circuit that is used to control a size of an image data, a first memory, and a digital/analog signal transforming device and said first memory and said digital/analog signal transforming device are coupled with said scalar integrated circuit;
a rotational cantilever, said rotational cantilever comprising a first adjuster to adjust a length of said rotational cantilever and being connected to said base by using a first rotating shaft;
an image collecting device holder, said image collecting device holder comprising a second communication port and a second adjuster and being connected to said rotational cantilever by using a second rotating shaft;
a handle, said handle being connected to said base by using a third rotating shaft;
an image collecting device, said image collecting device being connected to said image collecting device holder by using said second communication port and being fixed on said image collecting device holder by using said second adjuster, wherein said image collecting device comprises:
an optical module, said optical module comprising a lens, a infrared cut and optical low pass filter, and a charge coupled device to be used to catch said image data, wherein said lens coupled with said infrared cut and optical low pass filter and said infrared cut and optical low pass filter is coupled with said charge coupled device;
a chip, said chip comprises a microprocessor control unit and a color processor to control said image data proceeding with a color processing process;
a second memory, said second memory being coupled with said chip;
a timing generator, said timing generator being coupled with said chip; and
a light source, said light source being coupled with said chip.

15. The method according to claim 14, wherein said base comprises a skid cushion module.

16. The method according to claim 14, wherein said rotational cantilever comprises a third adjuster to control said image collecting device holder.

17. The method according to claim 14, wherein said light source is a flash light.

18. The method according to claim 14, wherein said first memory is a dynamic random access memory.

19. The method according to claim 14, wherein said second memory is a memory buffer.

20. The method according to claim 14, wherein said image collecting device comprises an auto-switch to change a dynamic image collecting mode and a static image collecting mode with each other.

21. The method according to claim 14, wherein said scalar integrated circuit is used to adjust an amount of a frame rate of said image data.

22. The method according to claim 14, wherein said image data must pass through a analog signal processing process before said image data are transmitted from said optical module to said chip.

23. The method according to claim 14, wherein said rotational cantilever comprises a signal line to connect said second communication port to said circuit module.

24. A carried image processing device, wherein said carried image processing device comprises:
a base, said base comprising a control key module, a power connector, a skid cushion module, a first communication port, and a circuit module, wherein said circuit module comprises a scalar integrated circuit that is used to adjust an amount of a frame rate of image data, a first memory, and a digital/analog signal transforming device and said first memory and said digital/analog signal transforming device are coupled with said scalar integrated circuit;
a rotational cantilever, said rotational cantilever comprising a first adjuster and a second adjuster, wherein said first adjuster is used to adjust a length of said rotational cantilever and said rotational cantilever is connected to said base by using a first rotating shaft;
an image collecting device holder, said image collecting device holder comprising a second communication port and a third adjuster and being connected to said rotational cantilever by using a second rotating shaft, wherein a location of said image collecting device holder is adjusted by using said second adjuster;
a handle, said handle being connected to said base by using a third rotating shaft;
an image collecting device, said image collecting device being connected to said image collecting device holder by using said second communication port and being fixed on said image collecting device holder by using said third adjuster, wherein said image collecting device comprises:
an optical module, said optical module comprising a lens, a infrared cut and optical low pass filter, and a charge coupled device to be used to catch said image data, wherein said lens coupled with said infrared cut and optical low pass filter and said infrared cut and optical low pass filter is coupled with said charge coupled device;
a chip, said chip comprises a microprocessor control unit and a color processor to control said image data proceeding with a color processing process;
a power supply device, said power supply device being coupled with said chip and used to provide a electric power to said image collecting device;
a second memory, said second memory being coupled with said chip to be used to save said image data;
a timing generator, said timing generator being coupled with said chip; and
a light source, said light source being coupled with said chip.

25. The method according to claim 24, wherein said light source is a flash light.

26. The method according to claim 24, wherein said first memory is a dynamic random access memory.

27. The method according to claim 24, wherein said second memory is a memory buffer.

28. The method according to claim 24, wherein said image collecting device comprises an auto-switch to change a dynamic image collecting mode and a static image collecting mode with each other.

29. The method according to claim 24, wherein said scalar integrated circuit is used to adjust a size of said image data.

30. The method according to claim 24, wherein said image data must pass through a analog signal processing process before said image data are transmitted from said optical module to said chip.

31. The method according to claim 24, wherein said charge coupled device can be replaced by using a complementary metal-oxide semiconductor sensor.

32. The method according to claim 24, wherein said lens is a lens whose focal length is fixed.

33. The method according to claim 24, wherein said lens is a lens whose focal length can be adjusted by using hands.

34. The method according to claim 24, wherein said lens is a lens whose focal length can be adjusted automatically.

35. The method according to claim 14, wherein said scalar integrated circuit is used to adjust a frame size of said image data.
